(19) United States
(12) Patent Application Publication
(10) Pub. No.: US 2020/0169107 A1
(43) Pub. Date: May 28, 2020

(54) METHOD AND ELECTRONIC DEVICE FOR ADAPTIVELY CHARGING BATTERY

(71) Applicant: Samsung Electronics Co., Ltd., Suwon-si, Gyeonggi-do (KR)

(72) Inventors: Manish Amrutlal JOSHI, Patan (IN); Genemala HAOBIJAM, Manipur (IN)

(21) Appl. No.: 16/611,615

(22) PCT Filed: Aug. 7, 2018
(86) PCT No.: PCT/KR2018/008959

§ 371 Date: Nov. 7, 2019

(30) Foreign Application Priority Data
Aug. 10, 2017 (IN) 201741028435

(51) Int. Cl. H02J 7/00; H01M 10/44; H01M 10/48; H01M 10/42

(52) U.S. Cl. CPC H02J 7/007194; H02J 7/0048; H02J 7/00712; H01M 10/443; H01M 2220/30; H01M 10/425; H02J 7/005; H01M 2010/4271; H01M 10/486

(57) ABSTRACT

Provided is a method implemented in an electronic device and including determining a state of at least one of the electronic device and the battery, determining a charge rate of the battery based on the determined state of the at least one of the electronic device and the battery, and causing the battery to be charged based on the determined charge rate of the battery.

### TECHNICAL FIELD

The disclosure relates to charging a battery of an electronic device. More particularly, the disclosure relates to adaptively charging a battery of an electronic device.

### BACKGROUND ART

In general, a life expectancy of a battery is always considered to be a critical concern for most of electronic devices (i.e., portable electronic devices). As these electronic devices are power dependent on an electrical power supplied by the battery, thus maintaining a good health of the battery is very important.

Generally, a method used to charge the battery (for example, lithium ion battery) is a Constant Current (CC)—Constant Voltage (CV) method. A battery manufacturer specifies a maximum continuous charge/discharge current in relation to a rated capacity of the battery. For example, if the rated capacity is 1000 mAh, a charge rate of 1C corresponds to a charge current of 1000 mA.

The number of charge/discharge cycles may affect the life expectancy of the battery. For example, after 500 charge/discharge cycles, the capacity of the battery may fall below 80% or even 50% of its initial rated capacity. In a CC-CV charging profile, the charging current in the CC phase is fixed, which is generally in the range of 0.5C to 0.7C, so it may cause battery capacity degradation while battery aging.

### DISCLOSURE OF INVENTION

### Solution to Problem

Embodiments herein provide a method implemented in an electronic device including determining a state of at least one of the electronic device and the battery; determining a charge rate of the battery based on the determined state of the at least one of the electronic device and the battery; and causing the battery to be charged based on the determined charge rate of the battery.

Embodiments herein provide an electronic device including: a memory; a processor; and a battery management system, coupled to the processor and the memory, configured to: determine a state of at least one of the electronic device and the battery; determine a charge rate of the battery based on the determined state of the at least one of the electronic device and the battery; and causing the battery to be charged based on the determined charge rate of the battery.

### BRIEF DESCRIPTION OF DRAWINGS

The above and other aspects, features, and advantages of certain embodiments of the present disclosure will become more apparent from the following description taken in conjunction with the accompanying drawings, in which:

FIG. 1A is a graphical diagram depicting charging characteristics of a battery;

FIG. 1B is a chart illustrating changes of capacity and a charge rate of a battery based on aging of the battery;

FIG. 2A illustrates a block diagram illustrating various elements of an electronic device, according to an embodiment of the disclosure;

FIG. 2B is a block diagram illustrating various elements of a battery management system, according to an embodiment of the disclosure;

FIG. 3 is a flowchart illustrating a method of regulating a rate of charge of the battery, according to an embodiment of the disclosure;

FIG. 4 is a flowchart illustrating a method of calculating and applying an optimized rate of charge for charging the battery, according to an embodiment of the disclosure;

FIG. 5 is a flowchart illustrating a method of creating a battery profile, according to an embodiment of the disclosure;

FIG. 6 is a flowchart illustrating a method of setting an optimized charging rate, according to the embodiment of the disclosure;

FIG. 7 is a flowchart illustrating a method of accumulating charging/discharging current using coulomb counting, according to an embodiment of the disclosure;

FIG. 8 is a flowchart illustrating a method of creating the temperature profile based on the usage information of each application in the electronic device 100, according to an embodiment of the disclosure;

FIG. 9 is a flowchart illustrating a method of regulating one or more applications based on specific temperature profile, according to an embodiment of the disclosure;

FIG. 10 illustrates a User Interface (UI) of the electronic device in which one or more applications are regulated based on the present state of the battery, according to an embodiment of the disclosure;

FIG. 11 is a flowchart illustrating a method of controlling charging duration of the battery, according to an embodiment of the disclosure;

FIGS. 12A, 12B, 12C, and 12D illustrate a User Interface (UI) of the electronic device in which a charging speed mode is set by the user, according to an embodiment of the disclosure; and

FIGS. 13A, 13B, and 13C illustrate UIs of the electronic device in which the battery health characteristics are displayed, according to an embodiment of the disclosure.

Throughout the drawings, it should be noted that like reference numbers are used to depict the same or similar elements, features, and structures.

### BEST MODE FOR CARRYING OUT THE INVENTION

Aspects of the disclosure are to address at least the above-mentioned problems and/or disadvantages and to provide at least the advantages described below.

Embodiments herein provide a method implemented in an electronic device including determining a state of at least one of the electronic device and the battery; determining a charge rate of the battery based on the determined state of the at least one of the electronic device and the battery; and causing the battery to be charged based on the determined charge rate of the battery.

According to an embodiment, the charge rate of the battery is determined further based on a battery profile which is generated by measuring at least one battery parameter and a battery temperature at which the at least one battery parameter is measured.

According to an embodiment, the at least one battery parameter includes at least one of a battery capacity, an internal impedance, a charge state of the battery, a number of charging cycles, a number of discharging cycles, a discharge capacity, usage information of the electronic device, and usage information of an application in the electronic device.

According to an embodiment, the state of the at least one of the electronic device and the battery indicates at least one of temperature of the electronic device, temperature of the battery, present capacity of the battery, and applications running in the electronic device.

According to an embodiment, the temperature of the battery is determined by monitoring at least one of the temperature of the electronic device, ambient temperature, current consumption and charging temperature.

According to an embodiment, the method further includes: determining a charge duration of the battery based on the charge rate; and dynamically calculating the charge rate of the battery based on the determined charge duration, wherein the battery is charged based on the dynamically calculated charge rate in subsequent charge cycles.

According to an embodiment, the method further includes providing a recommendation to regulate, based on the determined state of the at least one of the electronic device and the battery, at least one application running in the electronic device. According to an embodiment, the method further includes: determining a remaining battery capacity based on the determined state of the at least one of the electronic device and the battery to determine a discharge duration of the battery; and providing a recommendation to regulate at least one application in the electronic device based on the determined discharge duration of the battery.

According to an embodiment, the method further includes: determining a hazard factor to the battery based on the determined state of the at least one of the electronic device and the battery; and providing a notification about the hazard.

Embodiments herein provide a non-transitory computer readable recording medium that stores instructions that, when executed by at least one processor, performs the above methods.

Embodiments herein provide an electronic device including: a memory; a processor; and a battery management system, coupled to the processor and the memory, configured to: determine a state of at least one of the electronic device and the battery; determine a charge rate of the battery based on the determined state of the at least one of the electronic device and the battery; and causing the battery to be charged based on the determined charge rate of the battery.

According to an embodiment, the battery management system is further configured to: determine a charge duration of the battery based on the determined charge rate; and determine a charge current rate of the battery based on the determined charge duration, wherein the battery is charged based on the determined charge current rate in subsequent charge cycles.

According to an embodiment, the battery management system is further configured to provide a recommendation to regulate, based on the determined state of the at least one of the electronic device and the battery, at least one application running in the electronic device.

According to an embodiment, the battery management system is further configured to: determine a remaining battery capacity based on the determined state of the at least one of the electronic device and the battery to determine a discharge duration of the battery; and provide a recommendation to regulate at least one application in the electronic device based on the determined discharge duration of the battery.

According to an embodiment, the battery management system is further configured to: determine a hazard factor to the battery based on the determined state of the at least one of the electronic device and the battery; and provide a notification about the hazard.

Embodiments herein provide a method for regulating a rate of charge of a battery. The method includes detecting that the battery is in a charging mode. Further, the method includes determining a present state of the electronic device and a present state of the battery. Further, the method includes dynamically determining an optimal rate of charge for charging the battery based on a battery profile, the present state of the electronic device and the present state of the battery, wherein the battery profile is at least one of a charging profile, a discharging profile and a temperature profile. Furthermore, the method includes charging the battery by applying the optimal rate of charge.

In an embodiment, the method for generating the battery profile includes measuring a plurality of battery parameters and a battery temperature at which the plurality of battery parameters are measured. Further, the method for generating the battery profile includes creating the battery profile based on the determined plurality of battery parameters and the battery temperature at which the plurality of battery parameters are measured. Furthermore, the method for generating the battery profile includes storing the battery profile to regulate the rate of charge of the battery.

In an embodiment, the present state of the electronic device and the present state of the battery indicate at least one of a present temperature of the electronic device, a present temperature of the battery, a present capacity of the battery, and applications running in the electronic device.

In an embodiment, the method further includes determining, by the battery management system, a charge duration for the battery based on the optimal rate of charge. Further, the method includes dynamically computing, by the battery management system, an optimal current rate for charging the battery based on the battery profile and the charging duration. Furthermore, the method includes applying, by the battery management system, the optimal current rate in subsequent charge cycles to charge the battery.

In an embodiment, the method further includes providing a recommendation to regulate at least one application based on the battery profile, the present state of the electronic device and the present state of the battery.

In an embodiment, the method further includes determining, by the battery management system, a remaining battery capacity based on the present state of the electronic device and the present state of the battery. Further, the method includes dynamically determining, by the battery management system, a discharge duration for the remaining battery capacity based on the battery profile, the present state of the electronic device and the present state of the battery. Furthermore, the method includes providing a recommendation to regulate at least one application based on the discharge duration.

In an embodiment, the method further includes determining the present state of the electronic device. Further, the method includes determining a hazard to the battery based on the present state of the electronic device and the battery profile. Furthermore, the method includes causing to display a notification about the hazard on a screen of the electronic device.

In an embodiment, the plurality of battery parameters comprises at least one of a battery capacity, an internal impedance, a state of charge of the battery, a number of charging cycles, a number of discharging cycles, a discharge capacity, usage information of the electronic device, and usage information of each application in the electronic device.

In an embodiment, the battery temperature is determined by monitoring a device temperature, an ambient temperature, a current consumption and a charging temperature.

In an embodiment, the battery profile is dynamically updated when a state of at least one of the battery parameters and the battery temperature is changed.

Accordingly, the embodiments herein provide an electronic device for regulating a rate of charge of a battery. The electronic device includes a processor, a memory and a battery management system, coupled to the processor and the memory, configured to detect that the battery is in a charging mode. Further, the battery management system is configured to determine a present state of the electronic device and a present state of the battery. Further, the battery management system is configured to dynamically determine an optimal rate of charge for charging the battery based on a battery profile, the present state of the electronic device and the present state of the battery, where the battery profile is at least one of a charging profile, a discharging profile and a temperature profile. Furthermore, the battery management system is configured to charge the battery by applying the optimal rate of charge.

These and other aspects of the embodiments herein will be better appreciated and understood when considered in conjunction with the following description and the accompanying drawings. It should be understood, however, that the following descriptions, while indicating preferred embodiments and numerous specific details thereof, are given by way of illustration and not of limitation. Many changes and modifications may be made within the scope of the embodiments herein without departing from the spirit thereof, and the embodiments herein include all such modifications.

### MODE FOR THE INVENTION

It may be advantageous to set forth definitions of certain words and phrases used throughout this document. The terms “include” and “comprise,” as well as derivatives thereof, mean inclusion without limitation. The term “or,” is inclusive, meaning and/or. The phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this document, and those of ordinary skill in the art should understand that in many, if not most instances, such definitions apply to prior, as well as future uses of such defined words and phrases.

The following description with reference to the accompanying drawings is provided to assist in a comprehensive understanding of various embodiments of the disclosure as defined by the claims and their equivalents. It includes various specific details to assist in that understanding, but these are to be regarded as merely exemplary. Accordingly, those skilled in the art will recognize that various changes and modifications of the various embodiments described herein can be made without departing from the scope and spirit of the disclosure. In addition, descriptions of well-known functions and constructions may be omitted for clarity and conciseness.

The terms and words used in the following description and claims are not limited to the bibliographical meanings, but are merely used to enable a clear and consistent understanding of the disclosure. Accordingly, it should be apparent to those skilled in the art that the following description of various embodiments of the disclosure is provided for illustration purpose only and not for the purpose of limiting the disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces

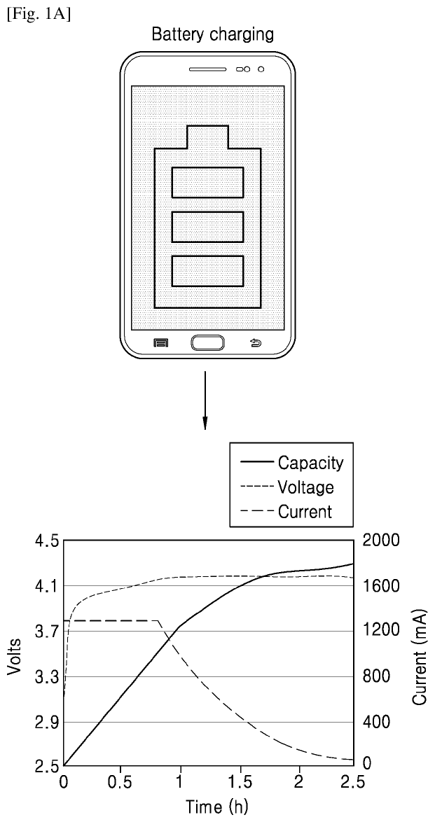

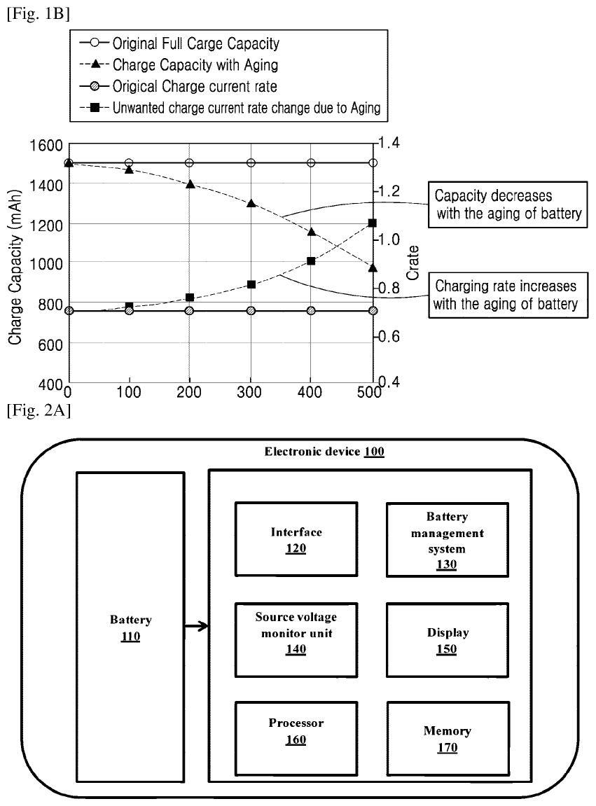

FIG. 1A is a graphical diagram depicting charging characteristics of a battery, and FIG. 1B is a chart illustrating changes of capacity and a charge rate of a battery based on aging of the battery.

In the Constant Current (CC)—Constant Voltage (CV) charging profile, charging current in the CC phase is fixed. For example, a charge current rate may be in a range of 0.5C to 0.7C. The charge current rate may be referred to as a charging current rate, a charge rate, a charging rate, a rate of charge, and a rate of charging in the disclosure. As battery capacity degrades by repeated charging and discharging, a charge rate of the battery may increase with respect to the degraded battery capacity. In this scenario, forcing higher current during charging may result in surplus ions being deposited on an anode in the form of Lithium metal. This may cause Lithium plating, which is an irreversible chemical reaction. That is, the unwanted increase in the charge rate may accelerate degradation of the battery capacity.

Another important parameter that influences the battery capacity is operating temperature. As mentioned above, when the current charging rate and the battery capacity degradation increases while the battery capacity decreasing, then the high current charging rate will further increase the battery temperature which therefore increases the rate of irreversible chemical reactions in the battery.

Thus, in order to reduce the battery degradation and further to improve the life expectancy of the battery it is desired to address the above mentioned disadvantages or other shortcomings or at least provide a useful alternative.

According to example embodiments disclosed herein, a temperature aware charging method may be provided, which may prevent the unwanted increase in the charge current rate while a battery aging. According to example embodiments, optimized current may be calculated and applied based on the age of the battery. Accordingly, the charge current rate (i.e., rate of charge) may be adjusted for reducing the battery degradation which may be caused by overvoltage.

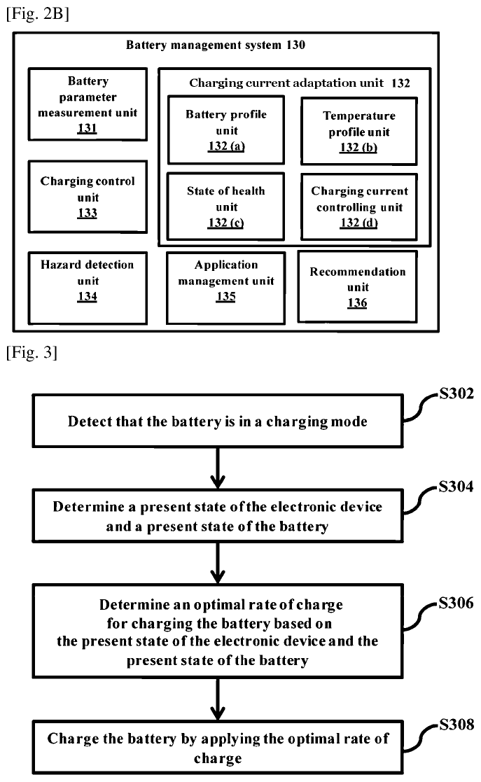

FIG. 2A illustrates a block diagram illustrating various elements of an electronic device 100, according to an embodiment of the disclosure.

In an embodiment, the electronic device 100 may be, for example, a laptop, a desktop computer, a mobile phone, a smart phone, a Personal Digital Assistant (PDA), a tablet, a phablet, a consumer electronic device, a dual display device, edge display, or any other electronic device. In another embodiment, the electronic device 100 may be a wearable device such as, for example, a smart watch, a smart bracelet, a smart glass, or the like. In another embodiment, the electronic device 100 may be an Internet of things (IoT) device.

The electronic device 100 may include a battery 110, an interface 120, and a battery management system 130, but is not limited thereto, and the electronic device 100 may include more or less elements than above described elements. The battery management system 130 is illustrated as being separate from other elements in FIG. 2A, but is not limited thereto. According to an embodiment, the battery management system 130 may be included in the battery 110 or the processor 160, or a part of the battery 110 or the processor 160. The electronic device 100 may further include (or, be associated with) a source voltage monitor unit 140. The electronic device 100 may further include a display 150, a processor 160, and a memory 170. The display 150 (e.g., a Cathode Ray Tube (CRT) display, a Liquid Crystal Display (LCD), Organic Light-Emitting Diode (OLED), a Light-emitting diode (LED), etc.) may be interfaced with the processor 160 (e.g., Central processing unit (CPU), Graphics processing unit (GPU), hardware chipset, etc.) which is communicatively coupled to the memory 170 (e.g., a volatile memory and/or a non-volatile memory). The memory 170 may include storage locations addressable through the processor 160. The electronic device 100 may include more or less elements than above described elements.

In an embodiment, the battery 110 may be a rechargeable battery with a predefined capacity set by the battery manufacturer or an Original Equipment Manufacturer (OEM). The characteristics of the battery 110 may includes type of battery (e.g., Lithium), total capacity (mAh) of the battery 110, constant current rate, nominal voltage level, allowable charge capacity, preset charge capacity, rated capacity of the battery 110, charge limit voltage, discharge limit voltage, maximum continuous charge current, maximum continuous discharge current, initial impedance, charging/discharging life cycles, etc.

Referring to FIG. 1B, as repeating charging and discharging of a battery, the capacity of the battery may decrease and may fall below 80% or even 50% of its initial rated capacity, which may reduce the allowable charge capacity. Whereas, the constant current (CC) rate remains as fixed by the battery manufacturer, which may result in overcharging of the battery) when the charging current is applied. As a result of this overcharging, the life expectancy of the battery may be reduced.

According to an embodiment, the CC rate may be adjusted or reduced based on the present state of the battery 110. This may be achieved by continuously monitoring a plurality of battery parameters and corresponding battery temperature at which the plurality of battery parameters are measured, which may be referred to as a temperature aware charging method. Further, the temperature aware charging method may prevent the unwanted increase (i.e., overcharging of the battery 110) in a charge current rate while the battery 110 aging.

The interface 120 may be configured to communicate with the battery 110 to receive the plurality of battery parameters. Further, the battery management system 130 may be configured to communicate with the interface 120 to extract the plurality of battery parameters and the corresponding battery temperature at which the plurality of battery parameters are measured (as detailed in conjunction with FIG. 2B). In another embodiment, the battery management system 130 may be a battery management system chipset integrated with the battery 110 or the processor 160.

The display 150 may be configured to display a battery usage interval, a battery charge indication, a battery temperatures status, a present state of the battery 110, a battery indicator (i.e., graphical, percentage, etc.), a remaining battery percentage, a battery status, battery drain notifications, etc.

The processor 160 may be configured to communicate with all the elements in the electronic device 100 to perform the functionalities of the corresponding elements.

FIG. 2B is a block diagram illustrating various elements of the battery management system 130, according to an embodiment of the disclosure.

Referring to FIG. 2B, the battery management system 130 may include a battery parameter measurement unit 131, a charging current adaptation unit 132, a charging control unit 133, a hazard detection unit 134, an application management unit 135, and a recommendation unit 136, but is not limited thereto, and the battery management system 130 may include more or less elements than above described elements. The elements of the battery management system 130 are illustrated as being included in the battery management system 130 in FIG. 2B, but are not limited thereto. According to an embodiment, the elements of the battery management system 130 may be included in the battery 110 or the processor 160, or a part of the battery 110 or the processor 160. According to an embodiment, some elements of the battery management system 130 may be included in or a part of the battery 110 while some other elements of the battery management system 130 being included in or a part of the processor 160. Although various units are depicted as separate units in FIG. 2B, the battery parameter measurement unit 131, the charging current adaptation unit 132, the charging control unit 133, the hazard detection unit 134, the application management unit 135, and the recommendation unit 136 may be implemented as at least one hardware processor. That is, the following operation performed in each of the unit may be performed by the at least one hardware processor. According to an embodiment, at least one units of the battery management system 130 may be implemented in at least one hardware device, at least one software module, or a combination of at least one hardware device and at least one software module.

The battery parameter measurement unit 131 may be configured to measure at least one of the plurality of battery parameters. In an embodiment, the plurality of battery parameters may include total battery capacity, last measured capacity of the battery 110 in mAh, multiplication factor for current temperature, an internal impedance, a charging state of the battery 110, a number of charging cycles, a number of discharging cycles, a discharge capacity, usage information of the electronic device 100, and usage information of each application installed in the electronic device 100.

Further, the battery parameter measurement unit 131 may be configured to measure the present temperature of the electronic device 100 or the battery 110. In an embodiment, the temperature may be measured or determined by monitoring temperature of the electronic device 100 temperature of the battery 110, ambient temperature of the electronic device 100 or the battery 110, current consumption or charging temperature of the electronic device 100 or the battery 110, and the like. Furthermore, the battery parameter measurement unit 131 may be configured to detect whether the battery 110 is bloated 110 and/or may be configured to detect the onset of impending bloating of the battery 110. For example, the battery parameter measurement unit 131 may be configured to determine parameters related to the pressure value of the battery 110 and the dimension of the battery 110. Further, based on the determined pressure value and the dimension of the battery 110, the battery parameter measurement unit 131 may be configured to detect the onset of impending bloating of the battery 110.

The battery 110 may bloat for numerous reasons, for example, over-charging, over-discharging, which indicate the loss of the capacity of the battery 110. According to an embodiment, possibility of bloating of the battery 110 may be reduced by applying the optimal rate of charge as per the present state (e.g., remaining battery capacity) of the battery 110.

The battery parameter measurement unit 131 may be configured to transmit the measured parameter (i.e., the measured battery parameters, corresponding temperature, voltage and total charge) to the charging current adaptation unit 132.

Referring to FIG. 2B, the charging current adaptation unit 132 may determine a charge rate of the battery 110. The charging current adaptation unit 132 may include a battery profile unit 132(a), a temperature profile unit 132(b), a state of health detector unit 132(c), and a charging current controller unit 132(d), but is not limited thereto, and the charging current adaptation unit 132 may include more or less elements than above described elements.

In an embodiment, the battery profile unit 132(a) may be configured to create a battery profile (e.g., ads shown in Table 1) based on the determined plurality of battery parameters and the battery temperature at which the plurality of battery parameters may be measured.

TABLE 1
Temperature range: 10° C. to 15° C.,
Device Mode: charging mode (1)

| Voltage level | | | | | | |
|---|---|---|---|---|---|---|
| change | Cycle 1 | Cycle 2 | Cycle 3 | . . . | Cycle 100 | |
| 4.2 | Data | Data | Data | . . . | Data | Average |
| 4.192 | Data | Data | Data | . . . | Data | Average |
| 4.184 | Data | Data | Data | . . . | Data | Average |
| . . . | . . . | . . . | . . . | . . . | . . . | . . . |
| 3.6 | Data | Data | Data | . . . | Data | Average |
| | | | | | | Final |

Where, Temperature range indicates a range of battery temperature which may be −50° C. to +50° C., Device Mode indicates a charging mode (1) or a discharging mode (0), Cycles 1 to 100 indicate charging and discharging cycles, Data indicates accumulated charge current at a particular voltage, and Final indicates sum of all average, which is used to determine the present battery capacity for Temperature Range.

The battery profile may include a battery impedance factor with respect to temperature, battery capacity, and battery temperature profile during usage of the electronic device 100, a charging profile and a discharging profile. The battery profile may be stored in the memory 170.

The charging profile may be created, with respect to temperature, during the charging state of the electronic device 100. The battery profile unit 132(a) may be configured to periodically receive the measured parameters of the battery parameter measurement unit 131 (during charging state of the electronic device 100) and create the charging profile for the battery 110. Similarly, the discharging profile may be created, with respect to temperature, when the electronic device 100 is in the discharging state. The battery profile unit 132(a) may be configured to periodically receive the measured parameters of battery parameter measurement unit 131 (during the discharging state of the electronic device 100) and create the discharging profile (e.g., discharging capacity profile) for the battery 110. The discharging capacity profile may be used to determine the health of the battery 110 and present battery capacity. The charging profile and the discharging profile may be different from each other, and consist of table with respect to −50° C. to +50° C. temperature in an interval of 5° C.

The temperature profile unit 132 (b) may be configured to create a temperature profile which includes records of the temperature and battery consumed by each application of the electronic device 100. Further, the temperature profile may further include a record of current temperature and last temperature at which the battery capacity was calculated last time. Furthermore, the temperature profile unit 132 (b) may provide a feedback periodically to the charging current controller unit 132(d).

Temperature is important factor for battery degradation as well as to determine the remaining battery capacity. For example, in Li-ion battery, as operating temperature increases, the internal resistance also increases which may reduce discharging capacity of the battery 110 as well as accelerate battery degradation. According to an embodiment, the state of health detecting unit 132(c) may be used to calculate the present capacity of the battery 110 based on the temperature profile. The state of health detecting unit 132(c) may utilize a battery discharging capacity profile data, an impedance data and the temperature profile in order to calculate the present battery capacity with respect to the temperature.

The charging current controller unit 132(d) may be configured to determine a charge rate of the battery 110 based on the battery profile, the present state of the electronic device 100 and the present state of the battery 110. In an embodiment, the charging current controller unit 132(d) may be configured to dynamically change a charge current rate at different temperatures with respect to the aging factor of the battery.

In an embodiment, the determined charge rate of the battery 110 may be referred to as an optimal rate of charge, and the optimal rate of charge may be calculated using Math Figure 1 shown below:

$${C}_{rate} = \frac{Ichg ( Ccap , Tbat , Tdev , Ui )}{Ccap ( Tbat , Tdev , Zb , Id )} C \qquad [ Math . 1 ]$$

Where, Crate=Charge rate, Ichg=Charging current, Ccap=Battery's present capacity, Tbat=Battery internal temperature, Tdev=Device temperature, Ui=User input/usage-profile factor, Zb=Battery impedance, Id=Discharging current.

According to an embodiment, the optimal rate of charge may be calculated based on nonlinear electrochemical phenomena which account thermal effects as well as user's request or usage profile.

According to an embodiment, the device temperature may be determined based on ambient temperature, temperature changes due to charging of the battery 110, and temperature changes due to running certain applications (i.e., discharging of the battery 110).

According to an embodiment, the remaining (present) capacity of the battery 110 may be calculated by considering the present temperature of the electronic device 100 as well as the temperature of the battery 110. Further, the charging current controller unit 132(d) may dynamically determine the charge current rate based on the present capacity of the battery 110, user inputs and user usage profile, which may provide an optimized charge current rate of charging the battery 110.

Further, the charging current controller unit 132(d) communicates with the temperature profile unit 132(b) to extract temperature data. Based on the temperature data, the charging current controller unit 132(d) may provide a notification to the user notifying the application performance. Further, if the user is charging the electronic device 100 while using the electronic device 100 (i.e., calling, playing games, etc.), the charging current controller unit 132(d) may change or decrease charging rate based on the temperature data, thereby reducing the temperature of the electronic device 100.

The charging current controller unit 132(d) may provide data related to optimized rate of charge to the charging control unit 133 so that the charging control unit 133 may apply the optimized rate of charge to charging the battery 110. The charging control unit 133 may be configured to control charging current for the battery 110 by applying the optimized rate of charge during a Pre-charging mode, a CC charging mode, and a CV charging mode of the battery 110.

The hazard detection unit 134 may be configured to determine a hazard to the battery 110 based on the present state of the electronic device 100 and the battery profile. In an embodiment, the hazard may be, for example, unwanted increase in temperature of the electronic device 100, unwanted increase in temperature of the battery 110, a certain application running in the electronic device 100 to increase the temperature, bloating point of the battery 110, etc. Further, the hazard detection unit 134 may be configured to display the notification about the hazard on the display 150.

According to an embodiment, a recommendation may be provided to the user on whether to stop charging or stop running a certain application to prevent battery degradation and also to assure user safety.

For example, if the user of the electronic device 100 is calling, playing games, messaging, browsing, and the like while the electronic device 100 is on a charge mode (through wired/wireless means), the charging rate of the battery 110 may be dynamically adjusted according to an embodiment, thereby, preventing heating or explosion of the battery 110 when the electronic device 100 is in physical contact with the user. Further, according to an embodiment, degradation of the battery may be prevented by maintaining the temperature limit and/or by recommending the user to terminate a certain application which is increasing the battery temperature.

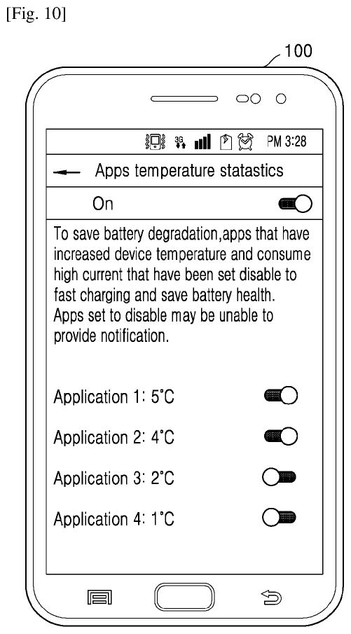

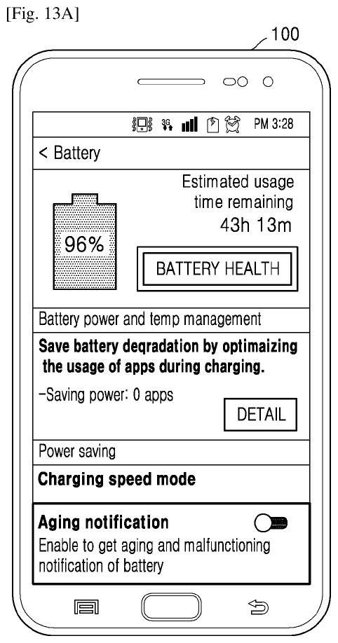

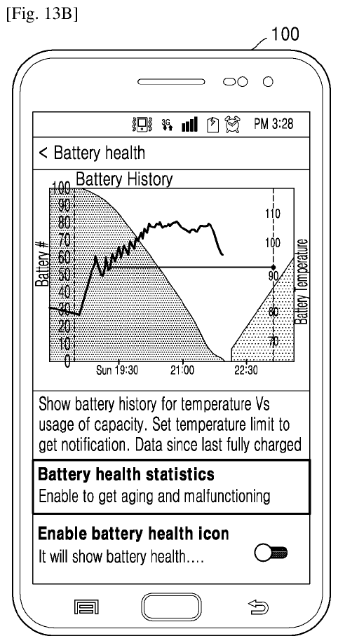

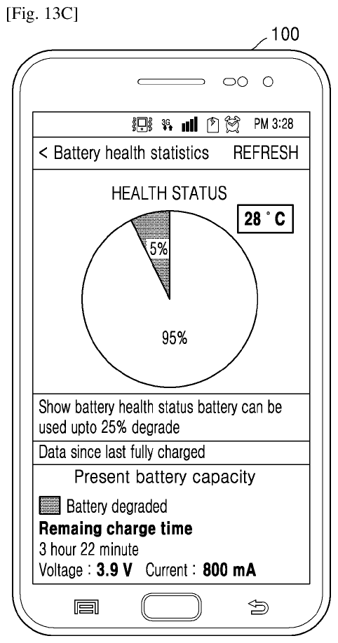

The application management unit 135 may be configured to manage applications temperature statistics (as detailed in FIG. 10). Furthermore, the state of health detecting unit 132 (c) may be configured to provide a battery health icon which give the notification regarding the application(s) which are causing bad impact on the battery 110 (as detailed in FIG. 13).

The recommendation unit 136 may be configured to provide at least one recommendation to regulate at least one application based on the battery profile, the present state of the electronic device 100 and the present state of the battery 110.

FIG. 3 is a flow chart illustrating a method for regulating the rate of charge of the battery 110 of the electronic device 100, according to an embodiment of the disclosure.

Referring to FIG. 3, at S302, the method may include detecting that the battery 110 is in a charging mode, by the battery management system 130. According to an embodiment, S302 may be omitted from the method.

At S304, the method may include determining the present state of the electronic device 100 and the present state of the battery 110, by the battery management system 130. In an embodiment, other elements of the electronic device 100 may perform such function of the battery management system 130.

At S306, the method may include determining the optimal rate of charge for charging the battery 110 based on the present state of the electronic device 100 and the present state of the battery 110, by the battery management system 130. In an embodiment, other elements of the electronic device 100 may perform such function of the battery management system 130. According to an embodiment, the optimal rate of charge for charging the battery 110 may be determined further based on the battery profile. According to an embodiment, the optimal rate of charge for charging the battery 110 may be determined dynamically based on a changed state of the electronic device 100 and a changed state of the battery 110.

At S308, the method may include charging the battery 110 by applying the optimal rate of charge by the battery management system 130. In an embodiment, other elements of the electronic device 100 may perform such function of the battery management system 130.

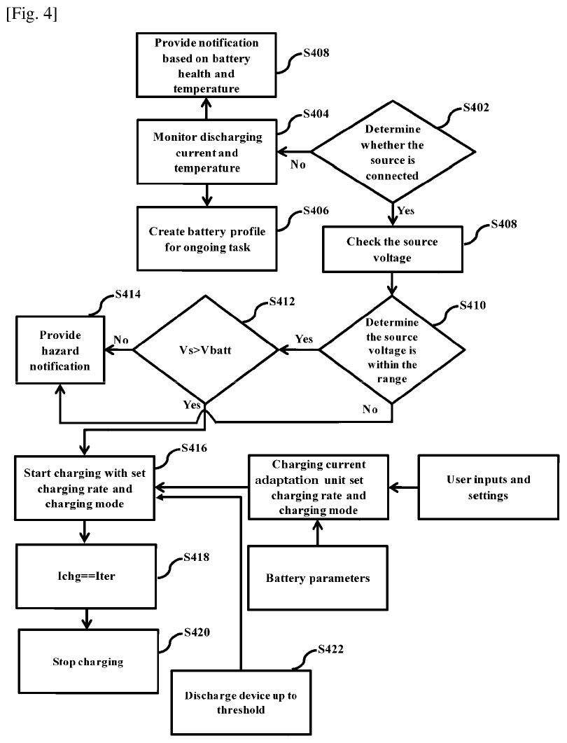

FIG. 4 is a flowchart illustrating a method for calculating and applying the optimized rate of charge for charging the battery 110, according to an embodiment of the disclosure.

Referring to FIG. 4, at S402, the method may include determining whether an external power source is connected to the electronic device 100, by the source voltage monitor unit 140. In an embodiment, other elements of the electronic device 100 may perform such function of the source voltage monitor unit 140.

According to an embodiment, the source voltage monitor unit 140 may be configured to determine, when the electronic device 100 is powered ON, whether the external power source is connected to the electronic device 100 in order to charge the battery.

When it is determined at S402 that the external power source is not connected, then at S404, the method may include monitoring discharging current and temperature. For example, the battery profile unit 132 (a) may be configured to monitor discharging current and temperature for the present state of the electronic device 100 and the present state of the battery 110.

According to an embodiment, the battery profile unit 132(a) may monitor discharging current and the temperature for a number N of battery cycles such as, for “N” battery cycles how much energy is utilized from the battery 110 with respect to operating temperature range. The “N” herein may be a natural and/or integer value. Further, the battery profile unit 132(a) may be configured to create the battery profile using the aforementioned monitored data for “N” battery cycles. The battery profile may be used to determine battery capacity for different temperatures, which may be used to determine the charging current rate for present condition and present temperature.

At S406, the temperature profile unit 132(b) may be configured to create the temperature profile and determine the current consumption for each application (for ongoing tasks) during discharging state. At S408, the temperature profile may be utilized to provide recommendation (for example, notification) to a user when the user accesses same application next time, provide an estimated usage time (remaining time of the battery) when the user accesses same application, how much temperature will be increased due to the usage of the application. If temperature may increase to a level which lead to the battery degradation or harm the user of the electronic device 100, then the hazard detection unit 132 may notify to the user to avoid such accidental events.

When it is determined at S402 that the external power source is connected to the electronic device 100, then at S410, the method may determine whether a source voltage (Vs) of the external power source is within a certain range i.e., Vs is higher than the minimum voltage (Vuv) required to charge and/or Vs is lower than the maximum voltage (Vov). When it is determined at S410 that the source voltage (Vs) is within the certain range then, at S412, the method may includes determining whether the source voltage (Vs) is higher than the battery voltage (Vbatt). When it is determined at S412 that the Vs<Vbatt, then at S414, the method may includes providing the hazard notification to the user notifying that a hazard may result from the low source voltage (Vs).

When it is determined at S412 that the Vs>Vbatt, then at S416, the method may include charging the battery with a set charging rate and a charging mode which are provided by the charging current controlling unit 132(d) based on user inputs, user settings, and a present state of the battery 110 which is determined based on battery parameters measured by the battery parameters measurement unit 131.

According to an embodiment, the charging control unit 133 may set the charging mode based on the battery voltage as a pre charging mode, a Constant Current (CC) mode or a Constant Voltage (CV) mode. The set charging rate may vary based on the charging mode. When the battery 110 reaches to the CC mode, the charging rate may be set based on the present temperature and health of the battery 110. When the user is using the electronic device 100, ongoing task temperature profile may be also considered to set the charging rate in order to prevent further increase in the electronic device 100 operating temperature.

According to an embodiment, when the temperature of the electronic device 100 keeps varying (i.e., not remaining as fixed) or keep increasing, then the recommendation unit 136, coupled to the hazard detection unit 134, may provide a recommendation to the user to either stop charging or stop background activity (or the ongoing task(s)) otherwise it may degrade battery.

At S418, the method may include determining that the charging current (Ichg) reaches to termination current (Iter). Further, at S420, the method may include stopping charging of the battery 110. When it is determined at S422 that the battery 110 voltage goes below to voltage threshold (i.e., discharge voltage level) then the battery 110 of the electronic device 100 may start to be charged again (as detailed in S416).

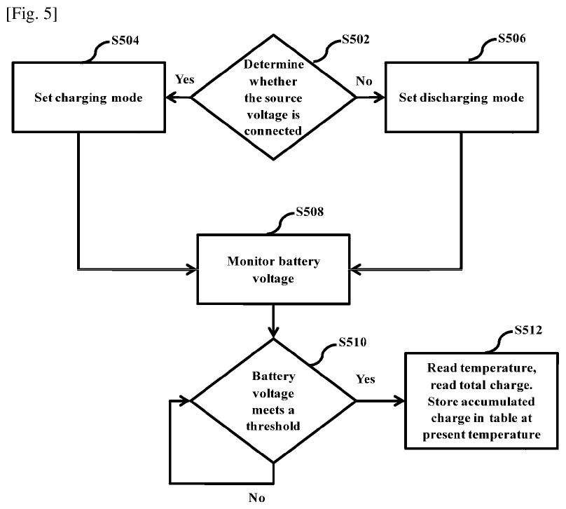

FIG. 5 is a flowchart illustrating a method for creating a battery profile, according to an embodiment of the disclosure

Referring to FIG. 5, at S502, the method may include determining whether the external power source is connected to the electronic device 100 in order to charge the battery 110, by the source voltage monitor unit 140. In an embodiment, other elements of the electronic device 100 may perform such function of the source voltage monitor unit 140.

When it is determined at S504 that the external power source is connected to the electronic device 100, then at S504, the method may include setting the electronic device 100 in a charging mode. When it is determined at S504 that the external power source is not connected to the electronic device 100, then at S506, the method may include setting the electronic device 100 in a discharging mode.

At S508, the method may include monitoring the battery voltage, by the battery parameter determination unit 131. In an embodiment, other elements of the electronic device 100 may perform such function of the battery parameter determination unit 131.

At S510, the method may include determining whether the battery voltage meets a threshold. For example, when the battery 110 is in the charging mode or the discharging mode, the battery parameter determination unit 131 may determine whether the battery voltage meets the threshold voltage “N” mV.

When it is determined at S510 that the battery voltage meets the threshold voltage, then at S512 the method may include determining battery parameters, for example, current temperature, current total charge, etc. According to an embodiment, the battery parameters may be utilized to create a battery profile which includes data regarding accumulated charge current at present temperature (as shown in the Table 1).

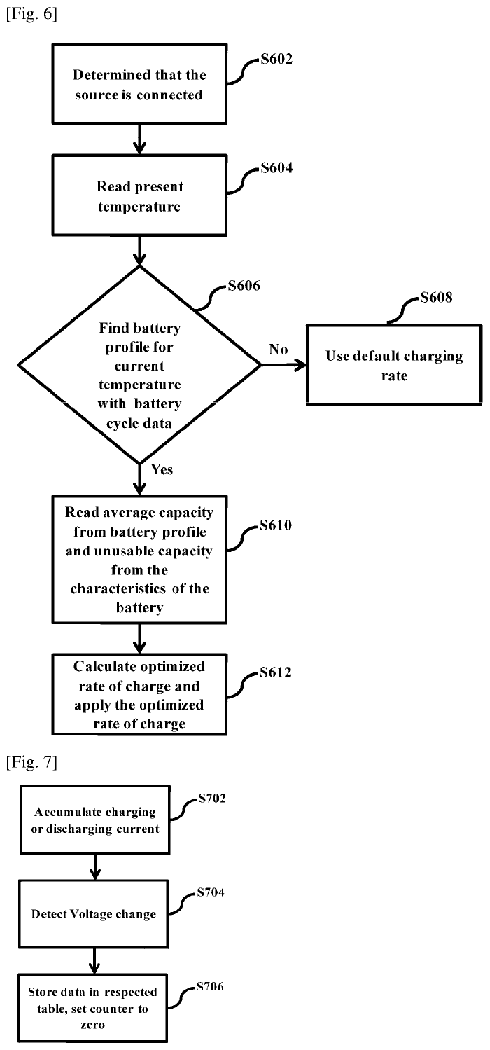

FIG. 6 is a flowchart illustrating the method to calculate and apply the optimized charging rate, according to the embodiment of the disclosure.

The battery profile may include data regarding each average of accumulated charge current at each voltage level and each average may be used, e.g., summed, to obtain estimated capacity (Measured capacity=Estimated capacity+unusable capacity). Further, the unusable battery capacity may be calculated from battery impedance data provided by the battery manufacturer. In another embodiment, the battery impedance data may be fetched from the battery 110 (e.g., smart battery) itself, if the battery 110 is capable to provide data. Thus, the charging current rate may be set to satisfy default charging rate as given in Math Figure. 1.

Referring to FIG. 6, at S602, the method may include determining that the external power source is connected, by the source voltage monitoring unit 140. In an embodiment, other elements of the electronic device 100 may perform such function of the source voltage monitor unit 140.

At S604, the method may include reading the present temperature of at least one of the battery 110 and the electronic device 100, by the battery parameter determination unit 131. In an embodiment, other elements of the electronic device 100 may perform such function of the battery parameter determination unit 131.

At S606, the method may include determining whether there exists any data (e.g., data tabulated as the battery profile) for the present temperature of the battery 110 and the present temperature of the electronic device 100 with “N” battery cycle, by the charging current controlling unit 132(d). In an embodiment, other elements of the electronic device 100 may perform such function of the charging current controlling unit 132(d).

When it is determined at S606 that no data is available for the present temperature of the battery 110 and the present temperature of the electronic device 100 with “N” battery cycle, then at S608, the method may include charging the battery 110 at the default charging rate.

When it is determined at S606 that there exists data for the present temperature of the battery 110 and the present temperature of the electronic device 100 with “N” battery cycle, then at S610, the method may include reading average capacity from the battery profile and unusable capacity from the characteristics of the battery 110. In an embodiment, the charging current controlling unit 132(d) may be configured to read the average capacity from battery profile and unusable capacity from the characteristics of the battery 110.

At S612, the method may include calculating the optimized rate of charge based on the battery profile and unusable capacity from the characteristics of the battery 110. The unusable capacity may be calculated based on the present state of the battery 110 and the present state of the electronic device 100.

FIG. 7 is a flowchart illustrating a method for accumulating charging/discharging current using coulomb counting, according to an embodiment of the disclosure.

Current may be read positive when discharging the battery 110 and negative when charging the battery 110. The current and voltage of the battery 110 may be read synchronously and resolution may be determined based on conversion of analog values to digital values. FIG. 7 gives an example of counter which restarts when a voltage level is changed by “N” mV.

Referring to FIG. 7, at S702, the method may include accumulating the charging or discharging current. In an embodiment, the battery management system 130 may be configured to accumulate the charging or discharging current. Further, at S704, the method may include detecting changes in the voltage. Furthermore, at S706, the method may include storing data in a corresponding field (e.g., the battery profile) and set counter to zero.

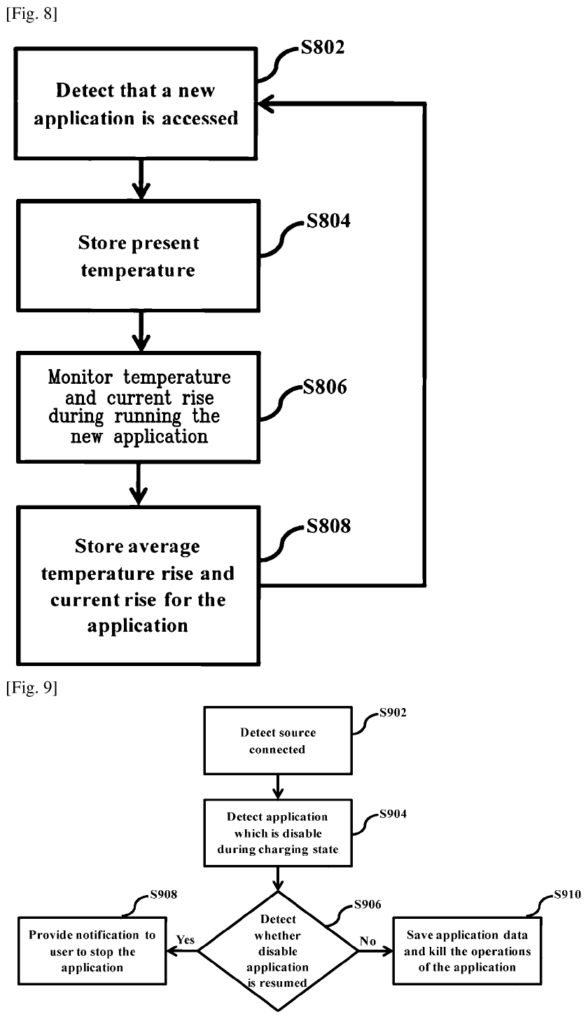

FIG. 8 is a flowchart illustrating a method for creating the temperature profile based on the usage information of each application in the electronic device 100, according to an embodiment of the disclosure.

Referring to FIG. 8, at S802, the method may include detecting that a new application is accessed in the electronic device 100. In an embodiment, the application management unit 135 may be configured to detect that the new application is accessed in the electronic device 100.

At S804, the method may include obtain and store temperature at which the new application was accessed, by the temperature profile unit 132(b).

At S806, the method may include monitoring the temperature and current during running the new application, by the temperature profile unit 132(b. For example, the temperature profile unit 132(b) may be configured to record temperature and current for every “N” cycle during running the new application, and further determine average of changes in temperature and current during running the new application.

At S808, the method may include storing data regarding the average of changes in temperature and current during running the new application. The data may be stored in the temperature profile.

FIG. 9 is a flowchart illustrating a method for regulating one or more applications based on specific temperature profile, according to an embodiment of the disclosure.

Referring to FIG. 9, at S902, the method may include detecting that the external power source is connected to the electronic device 100, by the source voltage monitor unit 140.

At S904, the method may include detecting one or more applications which are disabled during charging state. In an embodiment, the application management unit 135 may be configured to detect that one or more applications which are disabled during charging state.

At S906, the method may include detecting whether the disabled one or more applications are resumed in the electronic device 100. In an embodiment, the application management unit 135 may be configured to detect whether the disabled one or more applications are resumed in the electronic device 100.

When it is detected at S906 that disabled one or more applications are resumed in the electronic device 100, then at S908, the method may include providing a notification to a user to stop the resumed one or more applications. In an embodiment, the hazard detection unit 134 may detect a hazard to the battery due to resuming of the disabled one or more applications. Further, the recommendation unit 136 may be configured to recommend the user to stop running the one or more applications.

When it is detected at S906 that the disabled one or more applications are not resumed in the electronic device 100, then at S910, the method may include saving data of the one or more applications. In an embodiment, the application management unit 135 may be configured to save data of the one or more applications.

FIG. 10 illustrates a User Interface (UI) of the electronic device 100 in which one or more applications is regulated based on the present state of the battery, according to an embodiment of the disclosure.

Referring to FIG. 10, the application management unit 135 may be configured to provide application temperature statistics (i.e., temperature profile) which includes the details of temperature consumed by each application.

According to an embodiment, an option to stop the operations of particular applications that are increasing the temperature of the battery 110 and the temperature of the electronic device 100 may be provided to a user. More particularly, to enable fast charging during the charging state, the recommendation unit 136 may be configured to provide a recommendation to the user to stop running the particular applications (e.g., Application 1, Application 2, etc.) which highly consume current and causing temperature of the electronic device 100 or the battery 110 to increase. According to an embodiment, the battery degradation may be prevented and the life expectancy of the battery 110 may improve.

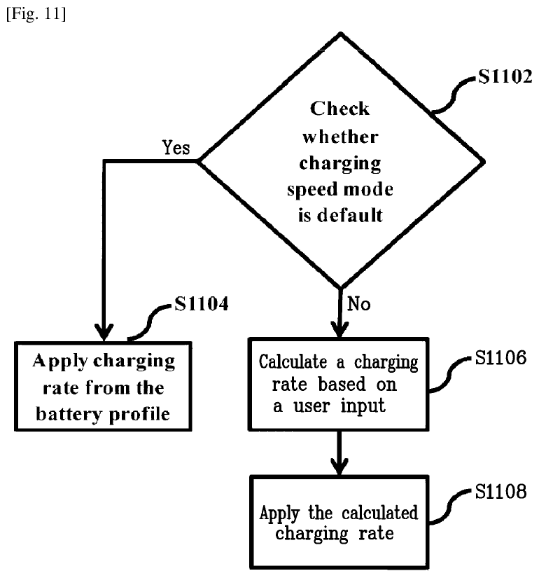

FIG. 11 is a flowchart illustrating a method for controlling charging duration of the battery, according to an embodiment of the disclosure.

Referring to FIG. 11, at S1102, the method may include determining whether the charging speed mode is default, by the charging current controlling unit 132(d). The charging speed mode may include a default charging speed mode, a customized charging speed mode, a minimum charging speed mode, and a maximum charging speed mode, but is not limited thereto.

When it is determined at S1102 that the charging speed mode is default, then at S1104, the method may include applying the charging rate from the battery profile, by the charging control unit 133.

When it is determined at S1102 that the charging speed mode is not default, then at S1106, the method may include calculating the charging rate as set by the user. In an embodiment, the charging current controlling unit 132(d) may be configured to calculate a charging rate based on a user input selecting the charging speed mode, and provides the calculated charging rate to the charging control unit 133.

At S1108, the charging control unit 133 may be configured to apply the calculated charging rate.

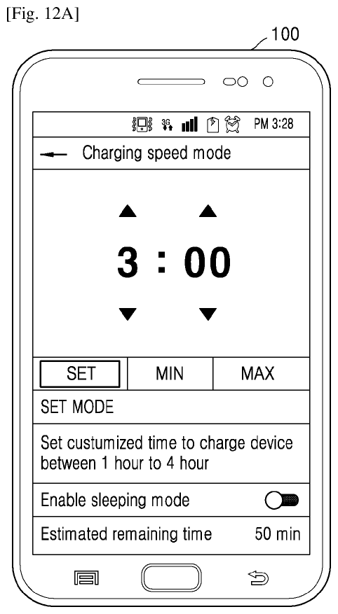

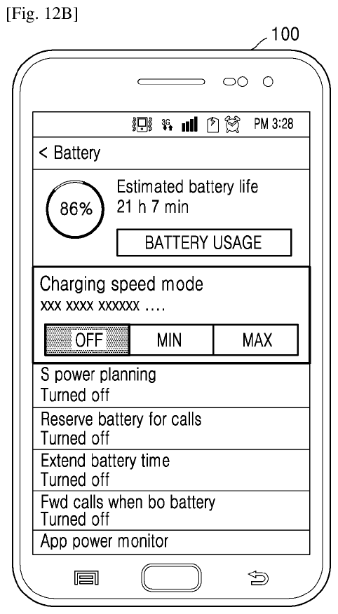

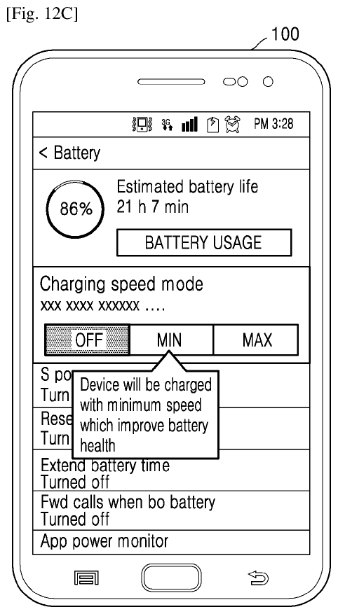

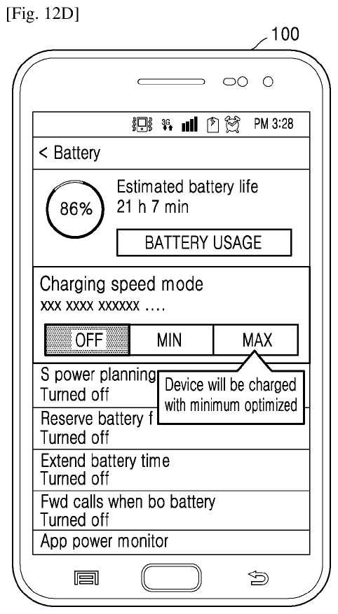

FIGS. 12A, 12B, 12C, and 12D illustrate a User Interface (UI) of the electronic device 100 in which the charging speed mode may be set by the user, according to an embodiment of the disclosure.

Referring to FIGS. 12A, 12B, 12C, and 12D, the user may set a charging speed mode. The charging speed mode may include a default charging speed mode, a customized charging speed mode, a minimum charging speed mode, and a maximum charging speed mode, but is not limited thereto. When charging speed mode is disabled, that is, the default charging speed mode, default charging rate (DCR) may be set as 0.7C. In this case charging current controller 133 may set the charging current rate to default charging rate (DCR).

In the customized charging speed mode, the user may input time to charge the battery 110 or may set the minimum charging speed mode (MIN) or the maximum charging speed mode (MAX). When the charging speed mode is disabled, that is, the default charging speed mode, then default process will follow. When the charging speed mode is set to be MIN or MAX then recommended MIN and MAX charging rate may be set. When specific time is set by the user, then charging rate will be calculated based on amount of time to charge, and remaining battery capacity to charge.

For example, if the user set 2 hour to charge, and remaining battery capacity is 90%, then a charging rate=((full capacity*0.9)/2 hour)/Full capacity.

According to an embodiment, rise in temperature of electronic device 100 may be reduced during charging and battery degradation may be prevented.

According to an embodiment, the charging speed mode may be set as a slow charging speed mode or the minimum charging speed mode when a user has enough time to charge the battery 110. The user may select the slow charging speed mode, which may enhance battery utilization capacity as well as reduce overcharging of the battery 110.

For example, when the electronic device 100 is in the charging mode for whole night, battery degradation may occur. In such scenario, the slow charging speed mode or the minimum charging speed mode may be selected, which may improve discharging capability of the battery 110 (as shown in Table 2).

TABLE 2

| | Discharge Condition | | |
|---|---|---|---|
| Current | 0.5 C | 1.0 C | 1.5 C |
| Relative Capacity | 100% | 90% | 80% |

According to an embodiment, a bloating condition of battery 110 may be monitored, which may prevent further degradation of the battery 110 and warn users when battery 110 needs to be replaced with new one.

For example, camera recording or dual camera recording may cause temperature to rise, and it may reach near to 42° C. In this scenario, according to an embodiment, the charging rate may be dynamically adjusted with respect to the temperature of the electronic device 100, which not only prevents the heating problem but also increases discharging capacity. According to an embodiment, a recommendation may be provided to a user to either reduce a charging rate of the battery 110 or stop background activity causing temperature to rise. If the temperature of the electronic device 100 does not decrease, then charging of the battery 110 may be stopped and a notification may be provided to a user to either stop using the electronic device 100 otherwise it may harm health of the battery.

Default charging rate may be 0.75 C for default case when charging speed mode is disabled, that is, the default charging speed mode. When a user selecting the minimum charging speed mode, then DCR may be adjusted to 0.5 C. When the charging speed mode is maximum charging speed mode, then DCR may be 1 C.

FIGS. 13A, 13B, and 13C illustrate UIs of the electronic device 100 in which the battery health characteristics are displayed, according to an embodiment of the disclosure.

A battery health option may be provided to show temperature and battery usage capacity (as shown in FIG. 13A). Further, a battery aging notification mode may be provided to a user, which may be enabled to provide one or more notifications regarding the aging and malfunctioning of the battery 110 (as shown in FIG. 13A). Furthermore, the battery health statistics including present capacity of the battery 110, initial capacity of the battery 110, remaining charge time, present voltage, present current, present temperature, an amount of degradation of the battery 110 (unusable battery capacity), and the like may be displayed to a user (as shown in FIGS. 13B and 13C).

The embodiments disclosed herein may be implemented using at least one software program running on at least one hardware device and performing network management functions to control specific elements. The elements shown in figures may be at least one hardware device, at least one software module, or a combination of at least one hardware device and at least one software module.

The foregoing description of the specific embodiments reveals the general nature of the embodiments herein so that others may, by applying current knowledge, readily modify and/or adapt the specific embodiments for various applications without departing from the generic concept. Therefore, such adaptations and modifications should and are intended to be comprehended within the meaning and range of equivalents of the disclosed embodiments. It is to be understood that the phraseology or terminology employed herein is for the purpose of description of the inventive concept and not for purpose of limitation. Therefore, while the embodiments herein have been described in terms of preferred embodiments, those skilled in the art will recognize that the embodiments herein may be modified within the spirit and scope of the embodiments as described herein in the appended claims.

1. A method of charging a battery of an electronic device, comprising:
determining a state of at least one of the electronic device and the battery;
determining a charge rate of the battery based on the determined state of the at least one of the electronic device and the battery; and
causing the battery to be charged based on the determined charge rate of the battery.

2. The method of claim 1, wherein the charge rate of the battery is determined further based on a battery profile which is generated by measuring at least one battery parameter and a battery temperature at which the at least one battery parameter is measured.

3. The method of claim 2, wherein the at least one battery parameter comprises at least one of a battery capacity, an internal impedance, a charge state of the battery, a number of charging cycles, a number of discharging cycles, a discharge capacity, usage information of the electronic device, and usage information of an application in the electronic device.

4. The method of claim 1, wherein the state of the at least one of the electronic device and the battery indicates at least one of temperature of the electronic device, temperature of the battery, present capacity of the battery, and applications running in the electronic device.

5. The method of claim 4, wherein the temperature of the battery temperature is determined by monitoring at least one of the temperature of the electronic device, ambient temperature, current consumption and charging temperature.

6. The method of claim 1, further comprising:
determining a charge duration of the battery based on the charge rate; and
dynamically calculating the charge rate of the battery based on the determined charge duration, wherein the battery is charged based on the dynamically calculated charge rate in subsequent charge cycles.

7. The method of claim 1, further comprising:
providing a recommendation to regulate, based on the determined state of the at least one of the electronic device and the battery, at least one application running in the electronic device.

8. The method of claim 1, further comprising:
determining a remaining battery capacity based on the determined state of the at least one of the electronic device and the battery to determine a discharge duration of the battery; and
providing a recommendation to regulate at least one application in the electronic device based on the determined discharge duration of the battery.

9. The method of claim 1, further comprising:
determining a hazard factor to the battery based on the determined state of the at least one of the electronic device and the battery; and
providing a notification about the hazard.

10. A non-transitory computer readable recording medium that stores instructions that, when executed by at least one processor, performs the method of claim 1.

11. An electronic device comprising:
a memory;
a processor; and
a battery management system, coupled to the processor and the memory, configured to:
determine a state of at least one of the electronic device and the battery;
determine a charge rate of the battery based on the determined state of the at least one of the electronic device and the battery; and
causing the battery to be charged based on the determined charge rate of the battery.

12. The electronic device of claim 11, wherein the charge rate of the battery is determined further based on a battery profile which is generated by measuring at least one battery parameter and a battery temperature at which the at least one battery parameter is measured.

13. The electronic device of claim 12, wherein the at least one battery parameter comprises at least one of a battery capacity, an internal impedance, a charge state of the battery, a number of charging cycles, a number of discharging cycles, a discharge capacity, usage information of the electronic device, and usage information of an application in the electronic device.

14. The electronic device of claim 12, wherein the battery profile is updated based on the measured at least one of battery parameter and the measured battery temperature.

15. The electronic device of claim 11, wherein the state of the at least one of the electronic device and the battery indicates at least one of temperature of the electronic device, temperature of the battery, present capacity of the battery, and applications running in the electronic device.

16. The electronic device of claim 15, wherein the temperature of the battery is determined by monitoring at least one of the temperature of the electronic device, ambient temperature, current consumption and charging temperature.

17. The electronic device of claim 11, wherein the battery management system is further configured to:
determine a charge duration of the battery based on the charge rate; and
dynamically calculate the charge rate of the battery based on the determined charge duration, wherein the battery is charged based on the dynamically calculated charge rate in subsequent charge cycles.

18. The electronic device of claim 11, wherein the battery management system is further configured to provide a recommendation to regulate, based on the determined state of the at least one of the electronic device and the battery, at least one application running in the electronic device.

19. The electronic device of claim 11, wherein the battery management system is further configured to:
determine a remaining battery capacity based on the determined state of the at least one of the electronic device and the battery to determine a discharge duration of the battery; and
provide a recommendation to regulate at least one application in the electronic device based on the determined discharge duration of the battery.

20. The electronic device of claim 11, wherein the battery management system is further configured to:
determine a hazard factor to the battery based on the determined state of the at least one of the electronic device and the battery; and
provide a notification about the hazard.
